(19) United States
(12) Patent Application Publication
(10) Pub. No.: US 2017/0305009 A1
(43) Pub. Date: Oct. 26, 2017

(54) CONTROL SYSTEM AND CONTROL METHOD

(71) Applicant: YUTOU TECHNOLOGY (HANGZHOU) CO., LTD., Zhejiang (CN)

(72) Inventor: Tao JIANG, Zhejiang (CN)

(73) Assignee: YUTOU TECHNOLOGY (HANGZHOU) CO., LTD., Zhejiang (CN)

(21) Appl. No.: 14/760,957

(22) PCT Filed: Jun. 12, 2015
(86) PCT No.: PCT/CN2015/081385

§ 371 Date: Jul. 14, 2015

(30) Foreign Application Priority Data
Jan. 12, 2015 (CN) 201510015929.6

(51) Int. Cl. B25J 9/16; B25J 13/00

(52) U.S. Cl. CPC B25J 9/161; B25J 13/003; B25J 9/1697; B25J 9/1664; G05B 2219/33081; G05B 2219/40512

(57) ABSTRACT

The present invention includes a collection device a communication module, a first processing unit, a second processing unit and an execution unit. The benefit of the invention compared to the prior art is: by the cooperation of the using of the first processing unit and the second processing unit, the complicated operation with which the second processing unit can not accomplish is transferred to the first processing unit, the first processing unit then accomplish the operation, thus the processing speed and accuracy are increased. Meanwhile the simple logic operation processed by the first processing unit is transferred to the second processing unit the second processing unit then processes the logic operation and forms control signal to control the execution unit, so that the delayed processing of the execution unit is avoided.

### BACKGROUND OF THE INVENTION

### 1. Field of the Invention

The invention, relates to a field of robot technology, more specifically, to a control system and a control method for the behavior of a robot.

### 2. Description of the Related Art

Since 2000, with the development of the low power consumption chip based on ARM architecture, various sensor components are modularized and miniaturized, the voice technology and IMAGE technology ate improved rapidly, the robot industry has developed quickly. The modern, robot analyzes and executes the action which meets the requirement of the user by combining the recognizing instruction of the voice, expression and gesture made by the user and the various data sent back by the sensor. The processing method makes a breakthrough for the limits of the external input of the key and the mouse, or for the limits of the input of the precompile instruction, and it evolves the interactive model between machine and human beings into the interactive model by natural language or natural behavior.

Currently, there are two kinds of robot behavior controls: (1) Process all requests by the processor of the robot the server is functioned as a passive service provider, the behavior of the robot is limited, by the processor or by the control unit. This kind of process mode removes the dependency from the remote server, avoiding the behavior delay caused by the data transmission. However, this kind of robot has high requirements for the data processing capacity of the processor and the network cost is high as well. (2) Deliver all the behavior process to the remote server, the robot itself does not do any data analysis and processing. The robot itself only collects and transfers the data. As this kind of process manner simplifies the robot itself extremely, the manufacture cost decrease greatly. Nevertheless, all the data has to be determined after it has processed by the server, thus the reaction speed of the robot is affected. Meanwhile, the simplified front-end robot involve the modesty of the function without doing any complicated action.

To address the disadvantages of the prior art, the invention provides a control system and a control method with low cost and high efficiency.

The technical solution of the invention is:

A control system, applied to behavioral control device of home service robot comprising:

a collection device configured on a preset position of the robot to collect operation instructions input by the user, and to form m output of collection data;

a communication module including a first communication unit and a second communication unit, the first communication unit being connected to the collection device to receive the collection data, and transforming the collection, data to the output of the collection data, matched to the first communication unit;

a first processing unit connected to the first communication unit and the second communication unit respectively, to receive the collection data, and to recognize and process the collection data to form a control command output by the second communication unit;

a second processing unit connected to the second, communication unit to receive the control command output by the second, communication unit, and form output of control instruction according to the control command;

an execution unit connected to the second processing unit to execute actions under the effect of the control instruction, and the action being matched to the control instruction.

Preferably, the collection device comprises; p a sound capture module connected to the first communication unit to capture voice message, and to form an output of voice collection data matched to the first communication unit format;

an image capture module connected to the first communication unit to capture the image message, and to form an output of image collection data matched to the first communication unit format.

Preferably, the first processing unit comprises:

a voice recognition unit connected to the sound capture module to recognize voice control command according to the voice collection data;

an image recognition unit connected to the image capture module to recognize image control command according to the image collection data.

Preferably, it further comprises a detecting unit connected to the second processing unit, to detect the status information of tire robot at present physical environments and to form a detection information output to the second processing unit.

Preferably, the detecting unit comprises;

a temperature sensor connected to the second processing unit, to acquire the temperature information of present environment and to form a temperature signal output to the second processing unit;

a light sensor connected to the second processing unit, to acquire the light information of present environment, and to form a tight signal output to the second processing unit;

a displacement sensor connected to the second processing unit to acquire the position in formation of present environment and to form a position signal output to the second processing unit.

Preferably, the second processing unit comprises a memory unit, the memory unit has a plurality of preset scene modes and matching relation between the scene modes and the status information of physical environment.

Preferably, the execution unit comprises;

an audio play unit connected to the second processing unit to execute the action of audio play under the effect of the control signal which is output by the second processing unit and is in relevant to the audio play unit:

a light regulation unit connected to the second processing unit to execute the action of light regulation under the effect of the control signal which is output by the second processing unit and is in relevant to the light regulation unit;

a drive unit connected to the second processing unit to execute the action of position movement under the effect of the control signal, which is output by the second processing unit and is in relevant to the drive unit.

Preferably, the audio play unit is an audio play device inside the robot and/or an audio play device in the present environment where the robot locates, whose control end is connected to the corresponding output end of the second processing unit.

Preferably, the light regulation unit is the lighting system in the present environment where the robot locates, whose control end is connected to the corresponding output end of the second processing unit, to regulate the light intensity of the present environment.

A control method, applied to behavioral control device of home service robot, comprising the steps of:

controlling a collection device to collect operation instructions input by users to form an output of collection data;

controlling the first communication unit to receive the collection data, and to transform the collection data to the output of the collection data matched to the first communication unit;

controlling the first processing unit to receive the collection data, and to analyze and process the collection data, to form a control command output by the second communication unit;

controlling the second communication unit to transfer fee control command to the second processing unit;

controlling the second processing unit to form an output of control instruction according to the control command;

controlling the execution unit to execute the action under foe effect of the control instruction, and the action being matched to the control instruction.

The benefit of the invention compared to the prior art is; by the cooperation in the use of the first processing unit and the second processing unit the complicated operation with, which the second processing unit can not accomplish is transferred to the first processing unit, the first processing unit then accomplish the operation, thus the processing speed and accuracy are increased. Meanwhile the simple logic operation processed by the first processing unit is transferred to the second processing unit, the second processing unit then processes the logic operation, and forms control signal to control the execution unit so that the delayed processing of the execution unit is avoided, the processing demands of the second processing unit is reduced, the production, cost and the maintenance charge is decreased.

### BRIEF DESCRIPTIONS OF THE DRAWINGS

FIG. 1 is a structure schematic structure view of the control system according to the invention.

FIG. 2 is a flow chart of the control method according to the invention.

### DETAILED DESCRIPTIONS

The following is the further description of the invention by combining the drawing and the embodiments, and it can not be the limitation for the invention.

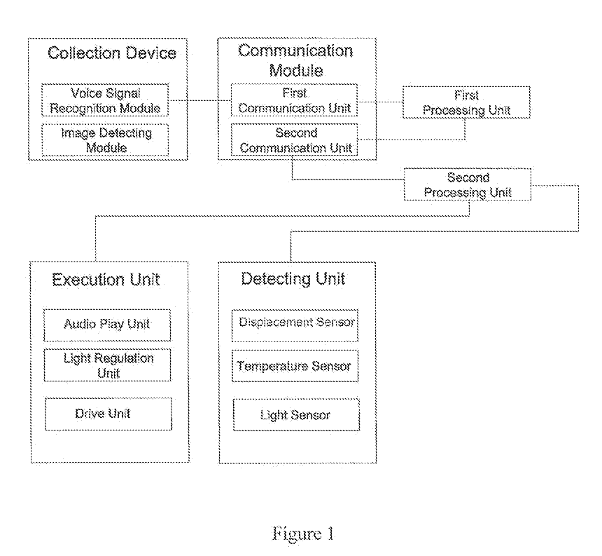

Referring to FIG. 1, it shows a control system which is applied to the robot behavioral control system, wherein it comprises:

a collection device configured on a preset position of the robot to collect operation instructions input by the user and to form ail output of collection data;

a communication module including a first communication unit and a second communication unit, the first communication unit being connected to the collection device to receive the collection data, and transforming the collection data to the output of the collection data matched to the first communication, unit;

a first processing unit connected to the first communication unit and the second communication unit respectively, to receive the collection data, and to recognize and process the collection data, to form a control command output by the second communication unit;

a second processing unit connected to the second communication unit to receive the control command, output by the second communication unit, and form output of control instruction according to the control command;

an execution unit connected to the second processing unit to execute actions under the effect of the control instruction* and the action being matched to the control instruction.

The operation principle of the invention is: the image collection device collects the operation instruction input by the user, and forms the collection data which is output to the first processing unit by the first communication unit the operation instruction can further be a gesture action command or voice command. The first processing unit recognizes the control command according to the collection data, and transfer the control command to the second processing unit by the second communication unit. The second processing unit forms a control instruction which controls the execution unit according to the control command. The first processing unit is a remote processing unit which can be formed by servers, to preprocess the collection signal output by the collection device, the first processing unit is mainly used to process and calculate the data relationship with complicated logic, and to transform it into data relationship with simple logic structure and output it. The second processing unit can be a local processing unit configured at the inner of the robot, the second processing unit is mainly used to process the data relationship with simple logic, and to form control instruction to drive the execution unit to execute corresponding action. When the communication module is failed and the transmission function is unavailable, the second processing unit can also execute the transmission and process with complicated logic, and form output of the control instruction. In the invention, by the cooperation in the use of the first processing unit and the second processing unit, the complicated operation with which the second processing unit spends a lot of time to accomplish is transferred to the first processing unit, and the operation is processed by the remote processing capacity of the first processing unit, thus the processing speed and accuracy are increased. Meanwhile the simple logic operation processed by the first processing unit is transferred to the second processing unit, the second processing unit then processes the logic operation, and forms control signal to control the execution unit, to avoid the delayed processing of the execution unit, and to decrease the processing demands of the second processing units to decrease the production cost and the maintenance charge including network maintenance cost, so that the user has well experience.

Based on the above technical solution, the collection device can comprises a sound capture module connected to the first communication unit to capture the voice message, and to form voice collection data matched to the first communication unit format, the voice collection data is output to the first processing unit, the first processing unit recognizes the voice control command according to the voice collection data.

Based on the above technical solution, the collection device can comprises an image capture module connected to the first communication unit to capture the image message, and to form output of image collection data matched to the first communication unit format. The first communication unit recognizes the image control command according to the image collection data, and transfers the image control command to the second processing unit by the second communication unit. The image information can include gesture action signal and face information.

Based on the above technical solution, the first communication unit can be long distance communication module, the second communication unit can be a Bluetooth communication module, a WiFi communication module, a Zigbee communication module or other close distance communication module.

Based on the above technical solution, the first processing unit comprises a voice recognition unit connected to the sound capture module to recognize voice control command according to the voice collection data.

Based on the above technical solution, the first processing unit comprises an image recognition unit connected to the image capture module to recognize image control command according to the image collection data.

Based on the above technical solution, the second processing unit comprises a memory unit, the memory unit has a plurality of preset scene modes and matching relations between the scene modes and the status information of physical environment. The scene modes include the information parameters such as time, data and geographical location.

Based on the above technical solution, the second processing unit is connected to the detecting unit the detecting unit is configured to detect the status of the present physical environment and to form detecting data output to the second processing data, the second processing data acquires the present scene mode according to the detecting data. The second processing unit further forms the control instruction according to the present scene mode and the control command output by the first processing unit, and transfers the control instruction to the execution unit. Meanwhile the second processing unit sends the present scene mode, control command and control instruction to the first processing unit by the second communication unit, the first processing unit analyzes the received data, to form analysis result to return to the second processing unit, the first processing unit updates the relationship between the physical environment in the memory unit and the scene mode according to the analysis result. By analyzing the operation the user “used to” do and acquiring the control instruction required by the user, the response is accomplished at once, and the operation, by the user is reduced. The operation the user “used to” do can be acquired by frequent operating instructions. And the method for the acquirement is various and it is not described any more.

Based on the above technical solution, the detecting unit comprises:

a temperature sensor connected to the second processing unit, to acquire the temperature information of present environment, and to form a temperature signal output to the second processing unit. The second proceeding unit forms an output of temperature control signal according to the present temperature signal.

a light sensor connected to the second processing unit to acquire the light information of present environment, and to form a light signal output to the second processing unit. The second processing unit forms an output of light control signal according to the present light signal.

a displacement sensor connected to the second processing unit, to acquire the position information of present environment, and to form a position signal output to the second processing unit. The second processing unit forms an output of position control signal according to the present position signal.

As a further preferred solution, the control signal comprises an audio control signal a light control signal, a displacement control signal the execution unit can also comprises:

an audio play unit connected to the second processing unit to execute the action of audio play under the effect of the control signal, which is output by the second processing unit and is in relevant to the audio play unit; further, the audio play unit is an audio play device inside the robot and/or an audio play device in the present environment where the robot locates, whose control end is connected to the corresponding output end of the second processing unit.

a light regulation unit connected to the second processing unit to execute the action of light regulation under the effect of the control signal which is output by the second processing unit and is in relevant to the light regulation unit; the light regulation unit is the lighting system in the present environment where the robot locates, whose control end is connected to the corresponding output end of the second processing unit to regulate the light intensity of the present environment.

a drive unit connected to the second processing unit to execute the action of position movement under the effect of the control signal which is output by the second processing unit and is in relevant to the drive unit For example, when the collection unit needs to collect the image information, the second processing unit sends out the control signal, the drive unit drives the robot to move under the effect of the control signal, and selects the image information which matches to the control signal.

The invention can also includes timing device connected to the control end of the audio play unit, the control end of the light regulation unit, and the control end of the temperature regulation unit respectively, to output the timing control signal, to timing control the audio play unit, light regulation unit, temperature regulation unit, so that the robot can be utilized conveniently.

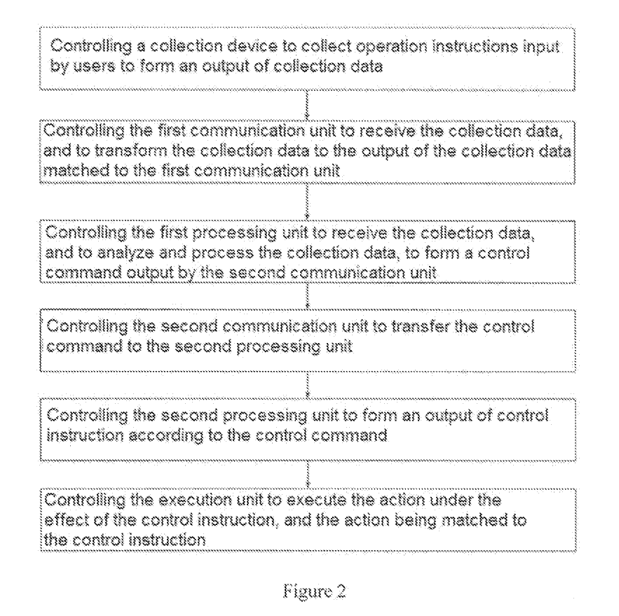

Referring to FIG. 2, the invention also provides a control method which, is applied to robot behavioral control system, wherein it comprises the steps of:

controlling a collection device to collect operation instructions input by users to form an output of collection data;

controlling the first communication unit to receive the collection data, and to transform the collection data to the output of the collection data matched, to the first communication unit;

controlling the first processing unit to receive the collection data, and to analyze and process the collection data, to form a control command output by the second communication unit;

controlling the second communication unit to transfer the control command to the second processing unit;

controlling the second processing unit to form an output of control instruction according to the control command;

controlling the execution unit to execute the action under the effect of the control instruction, and the action being matched to the control instruction.

The operation principle of the control method is described in the above description and it will not be explained any more.

The above description is only the preferred embodiments of the inventions and it docs not limit the implement method and protecting scope of the invention. It is obvious for the skilled in the art that the changing and variation made by the specification and drawings of the invention should fall into the scope of the invention.

What is claimed is:

1. A control system, applied to behavioral control device of home service robot, comprising;
a collection device configured on a preset position of the robot to collect operation instructions input by the user, and to form an output of collection data;
a communication module including a first communication unit and a second communication unit, the first communication unit being connected to the collection device to receive the collection data, and transforming the collection data to the output of the collection data matched to the first communication unit;
a first processing unit connected: to the first communication unit and the second communication unit respectively, to receive the collection data, and to recognize and process the collection data, to form a control command output by the second communication unit;
a second processing unit connected to the second communication unit to receive the control command output by the second communication unit and form output of control instruction according to the control command;
an execution unit connected to the second processing unit to execute actions under the effect of the control instruction, and the action being matched to the control instruction.

2. The control system as claimed in claim 1, wherein the collection device comprises:
a sound capture module connected to the first communication unit to capture voice message, and to form an output of voice collection data matched to the first communication unit format;
an image capture module connected to the first communication unit to capture the image message, and to form an output of image collection data matched to the first communication unit format.

3. The control system, as claimed in claim 2, wherein the first processing unit comprises:
a voice recognition unit connected, to the sound capture module to recognize voice control command according to the voice collection data;
an image recognition unit connected to the image capture module to recognize image control command according to the image collection data.

4. The control system as claimed in claim 1, wherein it further comprises a detecting unit connected to the second processing unit, to detect the status information of the robot at present physical environment. and to form a detection information output to the second processing unit.

5. The control system as claimed in claim 4, wherein the detecting unit comprises:
a temperature sensor connected to the second processing unit, to acquire the temperature information of present environment, and to form a temperature signal output to the second processing unit;
a light sensor connected to the second processing unit, to acquire the light information of present environment, and to form a light signal output to the second processing unit;
a displacement sensor connected to the second processing unit to acquire the position information of present environment and to form a position signal output to the second processing unit.

6. The control system as claimed in claim 4, wherein the second processing unit comprises a memory unit, the memory unit has a plurality of preset scene modes and matching relation between the scene modes and the status information of physical environment.

7. The control system, as claimed in claim 1, wherein the execution unit comprises:
an audio play unit connected to the second processing unit to execute the action of audio play under the effect of the control signal which is output by the second processing unit and is in relevant to the audio play unit;
a light regulation unit connected, to the second processing unit to execute the action of light regulation under the effect of the control signal which is output by the second processing unit and is in relevant to the light regulation unit;
a drive unit connected to the second processing unit to execute the action, of position movement under the effect of the control signal which is output by the second processing unit and is in relevant to the drive unit.

8. The control system as claimed in claim 7, wherein the audio play unit is an audio play device inside the robot and/or an audio play device in the present environment where the robot locates, whose control end is connected to the corresponding output end of the second processing unit.

9. The control system as claimed in claim 5, wherein the light regulation unit is the lighting system in the present environment where the robot locates, whose control end is connected to the corresponding output end of the second processing unit to regulate the light intensity of the present environment.

10. A control method, applied to behavioral control device of home service robot, comprising the steps of:
controlling a collection device to collect operation instructions input by users to form an output of collection data;
controlling the first communication unit to receive the collection data, and to transform the collection data to the output of the collection data matched to the first communication unit;
controlling the first processing unit to receive the collection data, and to analyse and process the collection data, to form a control command output by the second communication unit;
controlling the second communication unit to transfer the control command to the second processing unit;
controlling the second processing unit to form an output of control instruction according to the control command;
controlling the execution unit to execute the action under the effect of the control instruction, and the action being matched to the control instruction.
